(19) United States
(12) Patent Application Publication
(10) Pub. No.: US 2026/0014947 A1
(43) Pub. Date: Jan. 15, 2026

(54) BATTERY STORAGE CASE

(71) Applicant: HONDA MOTOR CO., LTD., Tokyo (JP)

(72) Inventors: Yu Iemura, Wako-shi (JP); Satoru Kawabe, Wako-shi (JP); Shutaro Sao, Wako-shi (JP); Ken Yasui, Wako-shi (JP)

(21) Appl. No.: 19/263,732

(22) Filed: Jul. 9, 2025

(30) Foreign Application Priority Data
Jul. 10, 2024 (JP) 2024-110812

(51) Int. Cl. B60R 16/04; B62D 21/02; H01M 50/249

(52) U.S. Cl. CPC B60R 16/04; B62D 21/02; H01M 50/249; H01M 2220/20

(57) ABSTRACT

This battery storage case that is attached to a frame member below a vehicle body and stores a battery cell therein includes a pair of main frame members extending in a first direction intersecting a vertical direction and arranged apart from each other in a second direction intersecting the first direction and the vertical direction, a cross member extending in the second direction and having both ends connected to each main frame member in the extending direction, and a bottom wall member connected to each main frame member to cover a lower space between the pair of main frame members and having an upper surface on which the battery cell is placed. The main frame member has an upper wall portion located at a higher height than the bottom wall member. The upper wall portion has an inclined region inclined downward from an inward side in the second direction, which is a side close to the cross member in the second direction, to an outward side in the second direction, which is a side away from the cross member, and a vehicle body connection region extending approximately horizontally from a lower end of the inclined region to the outward side in the second direction and connected to the frame member.

### CROSS-REFERENCE TO RELATED APPLICATION

The present application claims priority based on Japanese Patent Application No. 2024-110812, filed Jul. 10, 2024, the content of which is incorporated herein by reference.

### BACKGROUND OF THE INVENTION

### Field of the Invention

The present invention relates to a battery storage case in which battery cells are stored therein and to which a frame member of a vehicle is attached.

### Description of Related Art

As known, a vehicle underbody structure has a battery storage case storing battery cells therein and is installed on left and right side sills of the vehicle body (see, for example, Japanese Patent No. 7306544).

In the battery storage case disclosed in Japanese Patent No. 7306544, fixing pieces extending to an outward side in a vehicle width direction are provided on left and right side edges of the lower end side of the case body and the fixing pieces are fixed to lower surfaces of the corresponding left and right side sills (rocker panels) by fastening members. The fixing pieces provided extending on the case body are made of plate-shaped members and their bases (portions close to the case body) are inclined upward toward the outward side in the vehicle width direction.

In the vehicle underbody structure disclosed in Japanese Patent No. 7306544, an energy absorbing structure is provided on the left and right side sills that support the battery storage case. Thus, when a large external impact load acts on the side surface of the side sill, the energy of the impact load can be absorbed by the side sill.

### SUMMARY OF THE INVENTION

However, in the conventional battery storage case, bases of fixing pieces fastened to side sills are inclined upward from a side edge of a lower end of a case body toward an outward side in a vehicle width direction. Therefore, there is a problem because, when the side sill receives an impact load from a side and is significantly displaced toward an inward side in the vehicle width direction, the base of the fixing piece is bent upward and a large load is input from the side sill to an upper region of a side wall (a side frame) of the case body. In this case, it becomes necessary to provide a large cross member or a plurality of cross members in the case body from the viewpoint of protecting battery cells within the battery storage case. This causes the case body to become large and heavy, and therefore improvement is desired.

An aspect of the present invention aims to provide a battery storage case that can efficiently absorb an input impact load with parts other than battery cells while avoiding an increase in the overall size and weight. The present invention also contributes to energy efficiency by reducing the size and weight of the entire battery storage case.

In order to achieve the above-described objective, a battery storage case according to an aspect of the present invention employs the following configurations.

(1) According to an aspect of the present invention, there is provided a battery storage case that is attached to a frame member (e.g., a side sill 3 of an embodiment) below a vehicle body and stores a battery cell (e.g., a battery cell 6 of the embodiment) therein, the battery storage case including: a pair of main frame members (e.g., main frame members 11 of the embodiment) extending in a first direction intersecting a vertical direction and arranged apart from each other in a second direction intersecting the first direction and the vertical direction; a cross member (e.g., a first cross member 12f, a second cross member 12s, or a third cross member 12t of the embodiment) extending in the second direction and having both ends connected to each main frame member in the extending direction; and a bottom wall member (e.g., a bottom wall member 13 of the embodiment) connected to each main frame member to cover a lower space between the pair of main frame members and having an upper surface on which the battery cell is placed, wherein the main frame member has an upper wall portion (an upper wall portion 17 of the embodiment) located at a higher height than the bottom wall member, and wherein the upper wall portion has an inclined region (e.g., an inclined region 17b of the embodiment) inclined downward from an inward side in the second direction, which is a side close to the cross member in the second direction, to an outward side in the second direction, which is a side away from the cross member, and a vehicle body connection region (e.g., a vehicle body connection region 17c of the embodiment) extending approximately horizontally from a lower end of the inclined region to the outward side in the second direction and connected to the frame member.

According to the above-described aspect (1), when an impact load toward the inward side in the second direction is input to the vehicle body connection region of the main frame member through a frame member of the vehicle body, the load is concentrated near a boundary between the vehicle body connection region and the inclined region of the upper wall portion of the main frame member. At this time, because the inclined region of the upper wall portion is inclined downward toward the outward side in the second direction, a region near the boundary between the vehicle body connection region and the inclined region of the upper wall portion is bent and deformed in a concave shape while being displaced downward. Therefore, the main frame member transmits the impact load toward the inward side in the second direction without a part on the outward side in the second direction being significantly lifted upward. As a result, the impact load is also suitably transmitted to the bottom wall member on a downward side of the cross member through the main frame member.

Therefore, in the battery storage case of the present aspect, the impact load input from the frame member below the vehicle body can be efficiently absorbed not only by the cross member but also by the bottom wall member. Therefore, when the battery storage case of the present aspect is employed, it is possible to efficiently absorb the input impact load with parts other than the battery cells while suppressing an increase in the size of the cross member and an increase in the number of installed cross members.

(2) In the above-described aspect (1), a bent ridgeline (e.g., a bent ridgeline 20 of the embodiment) may be arranged to extend in the first direction between the inclined region of the upper wall portion and the vehicle body connection region.

According to the above-described aspect (2), because the bent ridgeline is arranged between the inclined region of the upper wall portion and the vehicle body connection region, when an impact load is input from the outward side of the main frame member in the second direction, the upper wall portion is likely to bend and deform in a downward concave shape starting from the bent ridgeline. Therefore, when this configuration is employed, it is easy to obtain a desirable deformation behavior of the upper wall portion that can effectively transmit the load from the main frame member to the bottom wall member.

(3) In the above-described aspect (1), the main frame member may further include a lower wall portion (e.g., a lower wall portion 18 of the embodiment) arranged below the upper wall portion and forming a closed cross section in the first direction together with the upper wall portion and an end of the lower wall portion on the inward side in the second direction may be arranged at a height close to the bottom wall member.

According to the above-described aspect (3), because the upper wall portion and the lower wall portion of the main frame member form the closed cross section in the first direction, even if a region near the boundary between the vehicle body connection region and the inclined region of the upper wall portion is bent and deformed downwardly in a concave shape, it is possible to efficiently transmit the impact load to the bottom wall member through the lower wall portion.

(4) In the aspect of the above-described aspect (3), a first reinforcing rib (e.g., a first reinforcing rib 21 of the embodiment), which is inclined downward toward the inward side in the second direction from a position on the inward side of the inclined region of the upper wall portion in the second direction and connects the upper wall portion and the lower wall portion, may be provided within the closed cross section of the main frame member.

According to the above-described aspect (4), the first reinforcing rib, which is inclined downward toward the inward side in the second direction from the position on the inward side of the inclined region of the upper wall portion in the second direction, is provided and the first reinforcing rib connects the upper wall portion and the lower wall portion. Therefore, if an impact load toward the inward side in the second direction is input to the vehicle body connection region of the main frame member, a reaction force is applied from the first reinforcing rib to a position on the inward side of the inclined region of the upper wall portion in the second direction so that the end of the inclined region on the inward side in the second direction is restricted from falling downward. As a result, the upper wall portion is easily bent and deformed in a concave shape downward near the boundary between the vehicle body connection region and the inclined region.

Moreover, because the first reinforcing rib is inclined downward toward the inward side in the second direction, a part of the impact load transmitted to the end of the inclined region of the upper wall portion on the inward side in the second direction is suitably transmitted to a lower wall portion side through the first reinforcing rib.

Therefore, when this configuration is employed, it becomes possible to suitably transmit the input impact load to the bottom wall member below the cross member through the main frame member.

(5) In the aspect of the above-described aspect (4), a second reinforcing rib (e.g., a second reinforcing rib 22 of the embodiment), which is inclined downward toward the inward side in the second direction from a position on the outward side of the inclined region of the upper wall portion in the second direction and connects the upper wall portion and the lower wall portion, may be provided within the closed cross section of the main frame member.

According to the above-described aspect (5), because the second reinforcing rib connected to the position on the outward side of the inclined region of the upper wall portion in the second direction is inclined downward toward the inward side in the second direction, a part of the impact load input to the vehicle body connection region can be suitably transmitted to the lower wall portion side through the second reinforcing rib.

Therefore, when this configuration is employed, even before a region near the boundary between the vehicle body connection region and the inclined region is significantly bent and deformed downward in a concave shape, the load can be efficiently transmitted to the bottom wall member through the second reinforcing rib and the lower wall portion.

(6) In the aspect of the above-described aspect (5), the upper wall portion may further include a base-side horizontal region (e.g., a base-side horizontal region 17a of the embodiment) extending approximately horizontally toward the inward side in the second direction on the inward side of the inclined region in the second direction.

According to the above-described aspect (6), because the base-side horizontal region is arranged on the inward side of the inclined region in the second direction, it is possible to suppress early deformation of a part on the inward side of the inclined region of the upper wall portion in the second direction at the initial stage of input of the impact load. Therefore, when this configuration is employed, it is possible to reliably bend and deform a region near the boundary between the vehicle body connection region and the inclined region first at the initial stage of input of the impact load.

(7) In the above-described aspect (1), the bottom wall member may have a multi-wall structure having a hollow portion.

According to the above-described aspect (7), because the bottom wall member has a highly rigid multi-wall structure, the impact load input through the main frame member can be reliably absorbed by the bottom wall member.

(8) In the above-described aspect (3), the main frame member may further include a hollow base frame portion (e.g., a base frame portion 15 of the embodiment) having the inward side in the second direction connected to the cross member and the bottom wall member and configured to rise upward from a height position connected to the bottom wall member, the upper wall portion and the lower wall portion may be connected to the outward side of the base frame portion in the second direction, and the upper wall portion may be connected to the base frame portion at a central position in the height direction or a position slightly below the central position.

According to the above-described aspect (8), because the upper wall portion is connected to the base frame portion at the central position in the height direction or at a position slightly below the central position, the impact load transmitted from the upper wall portion to the base frame portion can be more suitably transmitted to the bottom wall member. Moreover, in the later stage of input of the impact load, the base frame portion can be suitably deformed by the load input from the upper wall portion to the base frame portion. Therefore, the energy of the impact load can be absorbed by the deformation of the base frame portion.

According to the aspects of the present invention, an input impact load can be efficiently absorbed with parts other than battery cells while avoiding an increase in the overall size and weight. Therefore, when a battery storage case according to the present invention is employed, an overall battery storage case can be made smaller and lighter, thereby contributing to the energy efficiency of a vehicle.

### BRIEF DESCRIPTION OF THE DRAWINGS

FIG. 1 is a cross-sectional view showing a vehicle underbody structure according to an embodiment.

FIG. 2 is a perspective view of a battery storage case according to the embodiment.

FIG. 3 is an exploded perspective view of the battery storage case according to the embodiment.

FIG. 4 is a cross-sectional view of a part of the battery storage case according to the embodiment.

FIG. 5 is an explanatory cross-sectional view of load transmission of the battery storage case according to the embodiment.

FIG. 6 is an explanatory cross-sectional view of load transmission of a battery storage case according to a modified example.

FIG. 7 is an explanatory cross-sectional view for load transmission of a battery storage case according to another modified example.

FIG. 8 is an explanatory cross-sectional view of load transmission of a battery storage case according to yet another modified example.

### DESCRIPTION OF EMBODIMENTS

Hereinafter, embodiments of the present invention will be described with reference to the drawings. In the drawings, an arrow FR pointing to the front of a vehicle, an arrow UP pointing to the top of the vehicle, and an arrow LH pointing to the left side of the vehicle are indicated at appropriate positions. In the embodiments and their modified examples to be described below, the same reference signs are used to denote common parts and redundant description will be omitted.

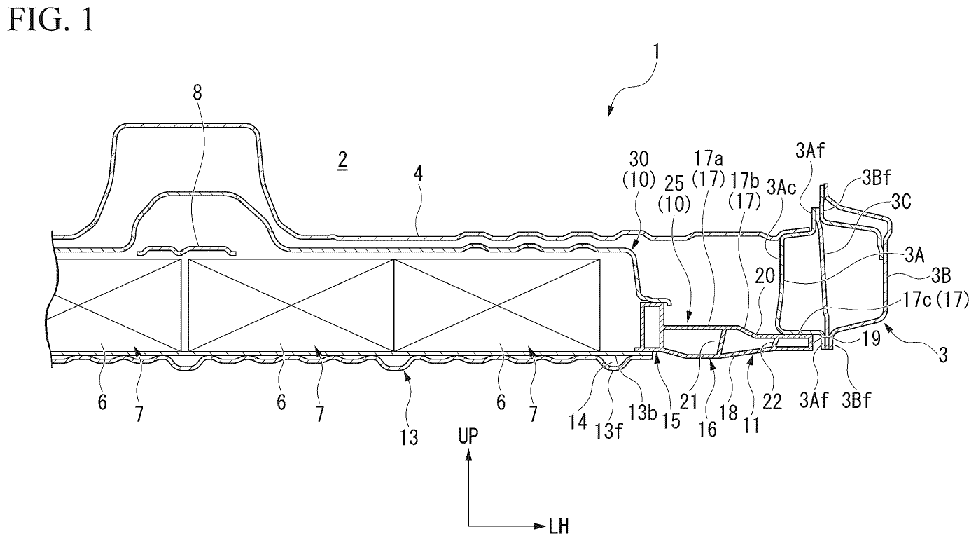

FIG. 1 is a diagram showing a vehicle underbody structure of a vehicle 1. FIG. 1 is a cross-sectional view of the underbody of the vehicle 1 cut in a direction perpendicular to a front-rear direction of the vehicle body.

A pair of side sills 3, which are frame members of the vehicle body and extend approximately in the front-rear direction of the vehicle body, are arranged at lower positions on both sides of a vehicle cabin 2 in a vehicle width direction. Only one of the side sills 3 is shown in FIG. 1. A floor panel 4 is installed on each of the left and right side sills 3. A battery storage case 10 is arranged below the floor panel 4 approximately along a lower surface of the floor panel 4. The battery storage case 10 includes a case body 25 having an upper surface side on which a plurality of battery cells 6, a control device (not shown), and the like are mounted and a cover member 30 covering over the case body 25.

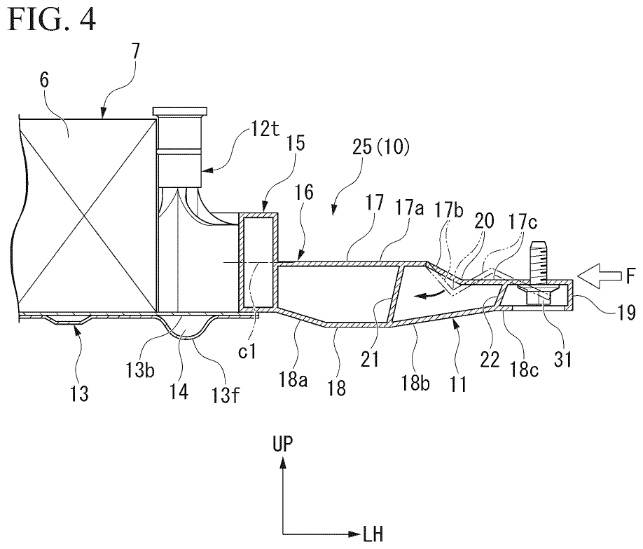

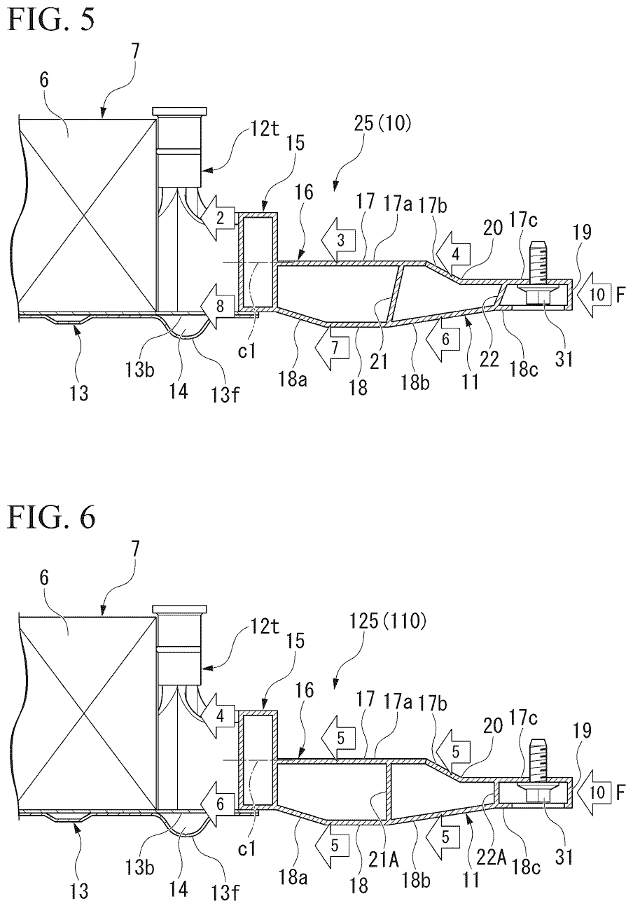

The case body 25 is formed in an approximately rectangular shape when seen from above. Left and right side edges of the case body 25 are fixed to the lower surfaces of the left and right side sills 3 by fastening members 31 (see FIGS. 4 and 5).

The side sill 3 is configured by sandwiching a stiffener 3C between a side sill inner 3A and a side sill outer 3B, each of which has a hat-shaped cross section. The side sill inner 3A and the side sill outer 3B have upper and lower joining flanges 3Af and 3Bf. The upper and lower joining flanges 3Af and 3Bf of the side sill inner 3A and the side sill outer 3B are arranged opposite each other. The joining flanges 3Af and 3Bf opposite each other are connected by welding or the like with the stiffener 3C sandwiched therebetween.

The side sill inner 3A has an inner bulge 3Ac having a U-shaped cross section that bulges inward in the vehicle width direction from the bases of the upper and lower joining flanges 3Af and 3Bf. The left and right side edges of the case body 25 are fixed to a lower surface of an inner bulge 3Ac of the side sill inner 3A.

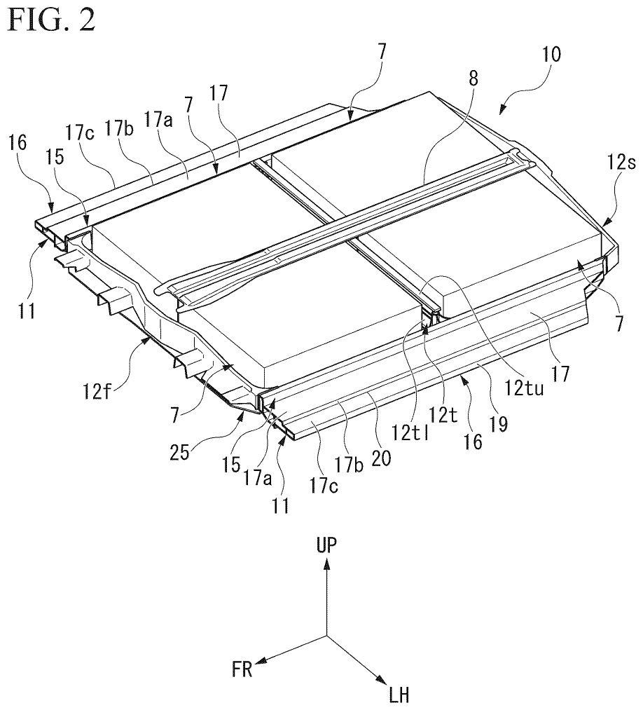

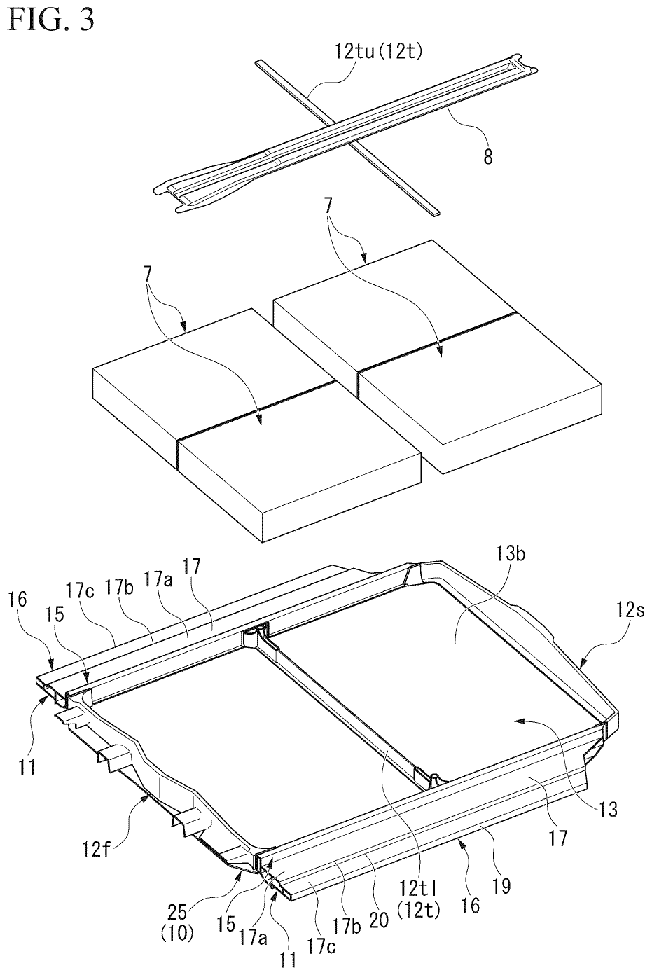

FIG. 2 is a perspective view of the battery storage case 10 and FIG. 3 is an exploded perspective view of the battery storage case 10. In addition, the cover member 30 is omitted in FIGS. 2 and 3.

The case body 25 of the battery storage case 10 includes a pair of main frame members 11 extending approximately in the front-rear direction of the vehicle body. The pair of main frame members 11 are arranged apart from each other in the vehicle width direction. The pair of main frame members 11 are connected by a first cross member 12f, a second cross member 12s, and a third cross member 12t extending in the vehicle width direction. The first cross member 12f has both ends in the extension direction connected to front ends of the left and right main frame members 11, and the second cross member 12s has both ends in the extension direction connected to rear ends of the left and right main frame members 11. Moreover, the third cross member 12t has both ends in the extension direction connected to approximately a central position of the left and right main frame members 11 in the front-rear direction.

The first cross member 12f and the second cross member 12s are fixed to the left and right main frame members 11 by welding. The third cross member 12t in the center includes a lower portion 12tl which is fixed to the left and right main frame members 11 by welding and an upper portion 12tu which is fixed to the top surface of the lower portion 12tl by bolting.

The case body 25 further includes a bottom wall member 13 covering a lower space between the pair of main frame members 11. The bottom wall member 13 is formed in a rectangular shape when seen from above and the pair of main frame members 11 and the lower ends of the first, second, and third cross members 12f, 12s, and 12t are coupled to the upper surface side of the bottom wall member 13. A plurality (four) of battery units 7 (a plurality of battery cells 6) are placed on the upper surface side of the bottom wall member 13. Two battery units 7 are placed side by side in the vehicle width direction on the front upper surface of the bottom wall member 13 in a state in which the third cross member 12t is sandwiched therebetween and the remaining two battery units 7 are similarly placed side by side in the vehicle width direction on the rear upper surface of the bottom wall member 13 in a state in which the third cross member 12t is sandwiched therebetween. The outer periphery of the battery units 7 (a plurality of battery cells 6) stored in the case body 25 is surrounded by the pair of main frame members 11 and the first, second, and third cross members 12f, 12s, and 12t.

Each battery unit 7 stored in the case body 25 is arranged apart from the adjacent main frame member 11 so that contact with the adjacent main frame member 11 is not made. In other words, a space is provided between the left or right main frame member 11 and the adjacent battery unit 7.

The bottom wall member 13 includes a base wall 7b facing a storage portion of the battery unit 7 and a flow path forming wall 7f joined to a lower surface side of the base wall 7b. The flow path forming wall 7f forms a coolant flow path 14 along which coolant is allowed to flow inside between the base wall 7b and the lower surface of the base wall 7b. The battery cells 6 stored in the battery storage case 10 are cooled by allowing the coolant to flow through the coolant flow path 14.

The bottom wall member 13 of the present embodiment constitutes a multi-wall structure having a hollow space therein according to a base wall 7b and a flow path forming wall 7f located below the base wall 7b.

Each battery unit 7 has a plurality of battery cells 6 stored in a stacked state within a unit cover that is a rectangular parallelepiped with a narrow width in an up-down direction. A predetermined number of battery cells 6 are grouped together as the battery unit 7 and stored within the battery storage case 10.

The number of battery units 7 stored in the battery storage case 10 is not limited to four, and any number can be selected in accordance with a size of the battery storage case 10, a layout of mounted parts, or the like.

Moreover, an equipment mounting frame 8 is installed on upper portions of the first cross member 12f and the second cross member 12s of the battery storage case 10. The equipment mounting frame 8 is installed on central portions of the first cross member 12f and the second cross member 12s in the vehicle width direction to straddle from the front to the rear above a central region of the four battery units 7 in the vehicle width direction. Control equipment and its wiring (not shown) are mounted on an upper portion of the equipment mounting frame 8.

In the present embodiment, the front-rear direction of the vehicle body is a first direction intersecting the vertical direction and the vehicle width direction is a second direction intersecting the first direction and the vertical direction. The pair of main frame members 11 extend in the first direction (the front-rear direction of the vehicle body) and are arranged apart from each other in the second direction (the vehicle width direction). The first, second, and third cross members 12f, 12s, and 12t extend in the second direction (the vehicle width direction) and have both ends in the extension direction connected to the respective main frame members 11.

Moreover, in the present embodiment, the inward side in the vehicle width direction is the inward side in the second direction and the outward side in the vehicle width direction is the outward side in the second direction.

FIG. 4 is a cross-sectional view of a part of the battery storage case 10. FIG. 4 is a cross-sectional view of the battery storage case 10 cut in a direction perpendicular to the front-rear direction of the vehicle body.

The main frame member 11 has a hollow base frame portion 15 to which extension ends of the first, second, and third cross members 12f, 12s, and 12t are connected on a surface of the inward side in the vehicle width direction, and a hollow mounting frame portion 16 extending toward the outward side in the vehicle width direction from the end of the base frame portion 15 on the outward side in the vehicle width direction.

In the base frame portion 15, a cross section perpendicular to the front-rear direction of the vehicle body is formed in a vertically long rectangular shape. The rectangular cross section of the base frame portion 15 extends approximately in the front-rear direction of the vehicle body.

The mounting frame portion 16 has an upper wall portion 17 having an end on the inward side in the vehicle width direction connected to a central position c1 of the base frame portion 15 in the height direction and a lower wall portion 18 having an end on the inward side in the vehicle width direction connected to a lower end of the base frame portion 15. The lower wall portion 18 is arranged at a height position close to the bottom wall member 13 (substantially the same height as the bottom wall member 13). The ends of the upper wall portion 17 and the lower wall portion 18 on the outward side in the vehicle width direction are closed by end walls 19 that rise upward approximately in the vertical direction.

The mounting frame portion 16 forms a horizontally long, approximately rectangular closed cross section by a side wall of the base frame portion 15 on the outward side in the vehicle width direction, the upper wall portion 17, the lower wall portion 18, and the end wall 19. This closed cross section extends in the front-rear direction of the vehicle body.

Although the upper wall portion 17 is connected to the central position c1 of the base frame portion 15 in a height direction in the present embodiment, a connection position of the upper wall portion 17 to the base frame portion 15 may be a position slightly lower than the central position c1 of the base frame portion 15 in the height direction.

The upper wall portion 17 of the mounting frame portion 16 is arranged at a higher height position than the bottom wall member 13. The upper wall portion 17 includes a base-side horizontal region 17a extending approximately horizontally toward the outward side in the vehicle width direction from the side wall of the base frame portion 15, an inclined region 17b inclined downward toward the outward side in the vehicle width direction from the end of the base-side horizontal region 17a on the outward side in the vehicle width direction, and a vehicle body connection region 17c extending approximately horizontally toward the outward side in the vehicle width direction from the lower end of the inclined region 17b and connected to the lower surface of the inner bulge 3Ac of the side sill 3. A bent ridgeline 20 extending in the front-rear direction of the vehicle body is arranged between the inclined region 17b and the vehicle body connection region 17c.

The lower wall portion 18 includes a base-side region 18a extending toward the outward side in the vehicle width direction from the lower end of the side wall of the base frame portion 15, a gently inclined region 18b extending toward the outward side in the vehicle width direction while being gently inclined upward from the end of the base-side region 18a on the outward side in the vehicle width direction, and an outer extension region 18c extending approximately horizontally toward the outward side in the vehicle width direction from the upper end of the gently inclined region 18b. An end of the outer extension region 18c of the lower wall portion 18 and an end of the vehicle body connection region 17c of the upper wall portion 17 are connected by an end wall 19.

A first reinforcing rib 21, which is inclined downward toward the inward side in the vehicle width direction from a position on the inward side of the inclined region 17b of the upper wall portion 17 in the vehicle width direction (a position in the base-side horizontal region 17a close to the inclined region 17b), is provided within the closed cross section of the mounting frame portion 16 (the main frame member 11). The first reinforcing rib 21 has an upper end connected to the upper wall portion 17 and a lower end connected to a boundary between the base-side region 18a and the gently inclined region 18b of the lower wall portion 18.

Furthermore, a second reinforcing rib 22, which is inclined downward toward the inward side in the vehicle width direction from a position on the outward side of the inclined region 17b of the upper wall portion 17 in the vehicle width direction (a position close to the inclined region 17b in the vehicle body connection region 17c), is provided within the closed cross section of the mounting frame portion 16 (the main frame member 11). The second reinforcing rib 22 has an upper end connected to the upper wall portion 17 and a lower end connected to a boundary between the outer extension region 18c and the gently inclined region 18b of the lower wall portion 18.

The deformation behavior of the battery storage case 10 and the load transmission at that time when the battery storage case 10 storing the battery cells 6 (the battery units 7) is attached to the vehicle 1 and an impact load is input from the side of the vehicle body in this state will be described.

FIG. 5 is an explanatory cross-sectional view of load transmission of the battery storage case 10.

As shown in FIGS. 4 and 5, when an impact load F is input from the side of the vehicle 1, the impact load F is transmitted to the vehicle body connection region 17c of the main frame member 11 of the battery storage case 10 through one of the left and right side sills 3. When a load toward the inward side in the vehicle width direction is input to the vehicle body connection region 17c of the main frame member 11, the load is concentrated (on the bent ridgeline 20) near the boundary between the vehicle body connection region 17c and the inclined region 17b of the upper wall portion 17. At this time, because the inclined region 17b of the upper wall portion 17 is inclined downward toward the outward side in the vehicle width direction, a region near the boundary between the vehicle body connection region 17c and the inclined region 17b of the upper wall portion 17 is bent and deformed in a concave shape while being displaced downward, as indicated by a virtual line in FIG. 4. Therefore, the main frame member 11 transmits the impact load F to the inward side in the vehicle width direction without a part on the outward side in the vehicle width direction being significantly lifted upward. Therefore, many of the component forces of the impact load are transmitted from the main frame member 11 to the bottom wall member 13 with high rigidity.

At the beginning of the input of the impact load F, a region near the boundary between the vehicle body connection region 17c and the inclined region 17b of the upper wall portion 17 bends downward as described above, while a part on the outward side of the mounting frame portion 16 in the vehicle width direction is crushed and deformed while rotating to the inward side in the vehicle width direction together with the side sill 3 with the bent portion as a fulcrum. At this time, the upper wall portion 17 of the mounting frame portion 16 is supported by the first reinforcing rib 21 at a part on the inward side of the inclined region 17b in the vehicle width direction and the first reinforcing rib 21 is inclined downward toward the inward side in the vehicle width direction. Therefore, the downward collapse of a part on the inward side of the inclined region 17b of the upper wall portion 17 in the vehicle width direction is restricted by the first reinforcing rib 21. Therefore, the bending deformation near the boundary between the vehicle body connection region 17c and the inclined region 17b of the upper wall portion 17 progresses more reliably.

Moreover, many of the component forces of the impact load F input to the vehicle body connection region 17c on the upper wall portion 17 side of the mounting frame portion 16 are transmitted to the lower wall portion 18 through the second reinforcing rib 22 and the first reinforcing rib 21. Numbers shown within the arrows in FIG. 5 indicate a proportion of the load transmitted to each of the upper wall portion 17 and the lower wall portion 18 and a proportion of the load transmitted to the cross member (e.g., the third cross member 12t) and the bottom wall member 13 when the impact load input to the vehicle body connection region 17c is set to “10.”

As described above, in the battery storage case 10 of the present embodiment, the main frame member 11 has the upper wall portion 17 arranged at a higher height position than the bottom wall member 13, and the upper wall portion 17 includes the inclined region 17b and the vehicle body connection region 17c. Also, the inclined region 17b is inclined downward from the inward side toward the outward side in the vehicle width direction, and the vehicle body connection region 17c extends approximately horizontally from the lower end of the inclined region 17b toward the outward side in the vehicle width direction and is connected to the side sill 3, which is a frame member of the vehicle. Therefore, when an impact load toward the inward side in the vehicle width direction is input to the vehicle body connection region 17c of the main frame member 11 through the side sill 3 on the side of the vehicle, a region near the boundary between the vehicle body connection region 17c and the inclined region 17b of the upper wall portion 17 is bent and deformed in a concave shape while being displaced downward. Thereby, when an impact load is input, a part on the outward side of the main frame member 11 in the vehicle width direction is not significantly lifted upward, and the input load can be suitably transmitted to the bottom wall member 13 below the cross members 12f, 12s, and 12t through the main frame member 11.

Therefore, in the battery storage case 10 of the present embodiment, the impact load input from the side sill 3 can be efficiently absorbed not only by the cross members 12f, 12s, and 12t but also by the bottom wall member 13 having high rigidity in a horizontal direction. Therefore, when the battery storage case 10 of the present embodiment is employed, the input impact load can be efficiently absorbed by parts other than the battery cells 6 while suppressing an increase in the size of the cross members and an increase in the number of installed cross members.

Moreover, the battery storage case 10 of the present embodiment has a bent ridgeline 20 extending in the front-rear direction of the vehicle body between the inclined region 17b and the vehicle body connection region 17c of the upper wall portion 17 of the main frame member 11. Therefore, when an impact load is input from the outward side of the main frame member 11 in the vehicle width direction, the upper wall portion 17 is likely to bend and deform in a concave shape downward starting from the bent ridgeline 20. Therefore, when this configuration is employed, it is easy to obtain a desirable deformation behavior of the upper wall portion 17 that can suitably transmit the load from the main frame member 11 to the bottom wall member 13.

Moreover, in the battery storage case 10 of the present embodiment, the main frame member 11 has the upper wall portion 17 and the lower wall portion 18 and the upper wall portion 17 and the lower wall portion 18 form a closed cross section in the front-rear direction of the vehicle body. Also, the end of the lower wall portion 18 on the inward side in the vehicle width direction is arranged at a height close to the bottom wall member 13 (substantially the same height as the bottom wall member 13). Therefore, even if a region near the boundary between the vehicle body connection region 17c and the inclined region 17b of the upper wall portion 17 is bent and deformed downward in a concave shape when an impact load is input, the impact load can be efficiently transmitted to the bottom wall member 13 through the lower wall portion 18.

Furthermore, in the battery storage case 10 of the present embodiment, the first reinforcing rib 21, which is inclined downward toward the inward side in the vehicle width direction from a position on the inward side of the inclined region 17b of the upper wall portion 17 in the vehicle width direction, is provided within the closed cross section of the main frame member 11. The first reinforcing rib 21 is connected to the upper wall portion 17 and the lower wall portion 18. Therefore, when an impact load toward the inward side in the vehicle width direction is input to the vehicle body connection region 17c of the main frame member 11, a reaction force acts from the first reinforcing rib 21 so that the end of the inclined region 17b on the inward side in the vehicle width direction is restricted from falling downward. At this time, because the first reinforcing rib 21 is inclined downward toward the inward side of the vehicle width direction from a position on the inward side of the inclined region 17b in the vehicle width direction, the upper portion side does not fall to the inward side in the vehicle width direction under the load and the end of the inclined region 17b on the inward side in vehicle width direction can be restricted from falling downward. As a result, the upper wall portion 17 is easily bent and deformed in a concave shape downward near the boundary between the vehicle body connection region 17c and the inclined region 17b.

Moreover, in this configuration, because the first reinforcing rib 21 is inclined downward toward the inward side in the vehicle width direction, a part of the impact load transmitted to the end of the inclined region 17b of the upper wall portion 17 on the inward side in the vehicle width direction can be suitably transmitted to the lower wall portion 18 side through the first reinforcing rib 21.

Therefore, when the battery storage case 10 of the present embodiment is employed, the input impact load can be suitably transmitted to the bottom wall member 13 below the cross members 12f, 12s, and 12t through the main frame member 11.

Moreover, in the battery storage case 10 of the present embodiment, the second reinforcing rib 22, which is inclined downward toward the inward side in the vehicle width direction from a position on the outward side of the inclined region 17b of the upper wall portion 17 in the vehicle width direction, is provided within the closed cross section of the main frame member 11. The second reinforcing rib 22 is connected to the upper wall portion 17 and the lower wall portion 18. Therefore, a part of the impact load input to the vehicle body connection region 17c can be suitably transmitted to the lower wall portion 18 side through the second reinforcing rib 22. Therefore, even before a region near the boundary between the vehicle body connection region 17c and the inclined region 17b is significantly bent and deformed downward in a concave shape, the load can be efficiently transmitted to the bottom wall member 13 through the second reinforcing rib 22 and the lower wall portion 18.

FIG. 6 is a cross-sectional view similar to that of FIG. 5, showing a modified example in which the first reinforcing rib 21A and the second reinforcing rib 22A rise upward in the vertical direction without being inclined toward the inward side in the vehicle width direction from their upper ends to their lower ends.

In the case of this modified example, because the first reinforcing rib 21A and the second reinforcing rib 22A are not inclined toward the inward side in the vehicle width direction from the upper end to the lower end, the load cannot be transmitted to the bottom wall member 13 as efficiently as in the embodiment shown in FIG. 4 and FIG. 5. This is evident from the numbers of the load sharing ratios written within the arrows in FIG. 6. In the embodiments shown in FIG. 4 and FIG. 5, because the first reinforcing rib 21A and the second reinforcing rib 22A are inclined toward the inward side in the vehicle width direction from the upper end to the lower end, the input impact load can be efficiently transmitted to the bottom wall member 13.

Moreover, in the battery storage case 10 of the present embodiment, a base-side horizontal region 17a extending approximately horizontally toward the inward side in the vehicle width direction is provided on the inward side of the inclined region 17b of the upper wall portion 17 in the vehicle width direction. Thus, it is possible to suppress the early deformation of a part on the inward side of the inclined region 17b of the upper wall portion 17 in the vehicle width direction at the initial stage of input of an impact load. Therefore, when this configuration is employed, a region near the boundary between the vehicle body connection region 17c and the inclined region 17b can be reliably bent and deformed first at the initial stage of input of an impact load.

Moreover, the battery storage case 10 of the present embodiment has a multi-wall structure in which the bottom wall member 13 has a hollow portion. Therefore, when the battery storage case 10 of the present embodiment is employed, the impact load input through the main frame member 11 can be reliably absorbed by the bottom wall member 13 of the multi-wall structure having high rigidity in the horizontal direction.

Furthermore, the battery storage case 10 of the present embodiment includes a hollow base frame portion 15 that rises upward from a height position where the main frame member 11 is connected to the bottom wall member 13. The inward side of the base frame portion 15 in the vehicle width direction is connected to the cross members 12f, 12s, and 12t and the bottom wall member 13. The upper wall portion 17 and the lower wall portion 18 of the main frame member 11 are connected to the outward side of the base frame portion 15 in the vehicle width direction, and the upper wall portion 17 is connected to the central position c1 in the height direction of the base frame portion 15 or a position slightly lower than the central position c1. Therefore, when this configuration is employed, the impact load transmitted from the upper wall portion 17 to the base frame portion 15 can be more suitably transmitted to the bottom wall member 13. Moreover, in the later stage of input of the impact load, the base frame portion 15 can be suitably deformed by the load input from the upper wall portion 17 to the base frame portion 15. In other words, a load can be applied from the upper wall portion 17 to the approximate central position in the height direction of the hollow base frame portion 15, thereby allowing the base frame portion 15 to be suitably deformed.

Therefore, when this configuration is employed, the energy of the impact load can be efficiently absorbed by the deformation of the base frame portion 15.

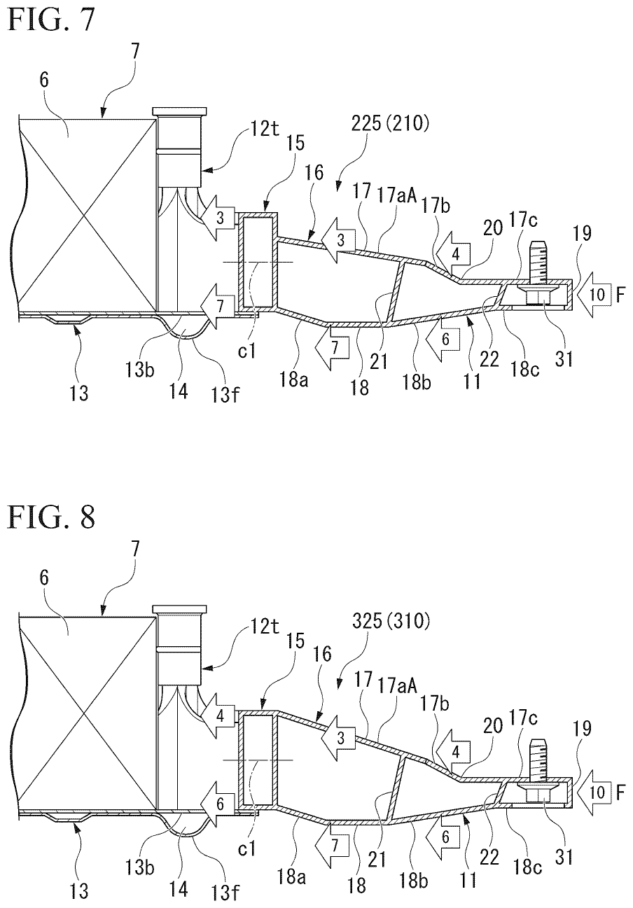

FIG. 7 is a cross-sectional view similar to that of FIG. 5, showing a modified example in which the upper wall portion 17 of the main frame member 11 is connected above the central position c1 of the base frame portion 15 in the height direction. Moreover, FIG. 8 is a cross-sectional view similar to that of FIG. 5, showing another modified example in which the upper wall portion 17 of the main frame member 11 is connected to an upper end of the base frame portion 15. In these modified examples, a base-side inclined region 17aA is arranged on the inward side of the inclined region 17b in the vehicle width direction, and an end of the base-side inclined region 17aA is connected to the base frame portion 15.

In the case of each of the modified examples shown in FIGS. 7 and 8, because the upper wall portion 17 is connected to a position above the central position c1 of the base frame portion 15 in the height direction, the load cannot be transmitted to the bottom wall member 13 as efficiently as in the embodiment shown in FIGS. 4 and 5. This is evident from the numbers of the load sharing ratios written within the arrows in FIGS. 7 and 8. In the embodiments shown in FIGS. 4 and 5, because the upper wall portion 17 is connected to the central position c1 of the base frame portion 15 in the height direction or a position slightly below the central position c1, the input impact load can be efficiently transmitted to the bottom wall member 13.

The present invention is not limited to the above-described embodiments and various design modifications are possible without departing from the scope and spirit of the present invention. For example, in the above-described embodiments, three cross members connected to the pair of main frame members 11 are provided apart from each other in the front-rear direction, but the number of cross members is not limited to three. The number of cross members may be four or more or two or less.

Moreover, in the above-described embodiment, the pair of main frame members 11 extend in the front-rear direction of the vehicle body and are arranged apart from each other in the vehicle width direction, and the first, second, and third cross members 12f, 12s, and 12t are arranged in the vehicle width direction. However, the arrangement of the main frame members and the cross members is not limited to this. For example, the pair of main frame members may extend in the vehicle width direction and may be arranged apart from each other in the front-rear direction of the vehicle body, and the cross members may be arranged in the front-rear direction of the vehicle body.

Although the bottom wall member 13 has a multi-wall structure including the base wall 7b and the flow path forming wall 7f in the above-described embodiments, the multi-wall structure is not limited thereto. The bottom wall member 13 may be configured to form a multi-wall structure with a dedicated member separate from the coolant flow path 14. In addition, it is not essential that the bottom wall member 13 has a multi-wall structure and it is only necessary for the bottom wall member 13 to have a structure with high rigidity in the horizontal direction.

### BRIEF DESCRIPTION OF THE REFERENCE SYMBOLS

3 Side sill (frame member)
6 Battery cell
10 Battery storage case
11 Main frame member
12f First cross member (cross member)
12s Second cross member (cross member)
12m Third cross member (cross member)
13 Bottom wall member
15 Base frame portion
17 Upper wall portion
17a Base-side horizontal region
17b Inclined region
17c Vehicle body connection region
18 Lower wall portion
20 Bent ridgeline
21, 21A First reinforcing rib
22, 22A Second reinforcing rib

What is claimed is:

1. A battery storage case that is attached to a frame member below a vehicle body and stores a battery cell therein, the battery storage case comprising:
a pair of main frame members extending in a first direction intersecting a vertical direction and arranged apart from each other in a second direction intersecting the first direction and the vertical direction;
a cross member extending in the second direction and having both ends connected to each main frame member in the extending direction; and
a bottom wall member connected to each main frame member to cover a lower space between the pair of main frame members and having an upper surface on which the battery cell is placed,
wherein the main frame member has an upper wall portion located at a higher height than the bottom wall member, and
wherein the upper wall portion has an inclined region inclined downward from an inward side in the second direction, which is a side close to the cross member in the second direction, to an outward side in the second direction, which is a side away from the cross member, and a vehicle body connection region extending approximately horizontally from a lower end of the inclined region to the outward side in the second direction and connected to the frame member.

2. The battery storage case according to claim 1, wherein a bent ridgeline is arranged to extend in the first direction between the inclined region of the upper wall portion and the vehicle body connection region.

3. The battery storage case according to claim 1,
wherein the main frame member further includes a lower wall portion arranged below the upper wall portion and forming a closed cross section in the first direction together with the upper wall portion, and
wherein an end of the lower wall portion on the inward side in the second direction is arranged at a height close to the bottom wall member.

4. The battery storage case according to claim 3, wherein a first reinforcing rib, which is inclined downward toward the inward side in the second direction from a position on the inward side of the inclined region of the upper wall portion in the second direction and connects the upper wall portion and the lower wall portion, is provided within the closed cross section of the main frame member.

5. The battery storage case according to claim 4, wherein a second reinforcing rib, which is inclined downward toward the inward side in the second direction from a position on the outward side of the inclined region of the upper wall portion in the second direction and connects the upper wall portion and the lower wall portion, is provided within the closed cross section of the main frame member.

6. The battery storage case according to claim 5, wherein the upper wall portion further includes a base-side horizontal region extending approximately horizontally toward the inward side in the second direction on the inward side of the inclined region in the second direction.

7. The battery storage case according to claim 1, wherein the bottom wall member has a multi-wall structure having a hollow portion.

8. The battery storage case according to claim 3,
wherein the main frame member further includes a hollow base frame portion having the inward side in the second direction connected to the cross member and the bottom wall member and configured to rise upward from a height position connected to the bottom wall member,
wherein the upper wall portion and the lower wall portion are connected to the outward side of the base frame portion in the second direction, and
wherein the upper wall portion is connected to the base frame portion at a central position in the height direction or a position slightly below the central position.
